(19) United States
(12) Patent Application Publication
(10) Pub. No.: US 2012/0019481 A1
(43) Pub. Date: Jan. 26, 2012

(54) Controller of Contact Sensing Type Using Optical Principle for Controlling a Pointer on a Display Screen

(76) Inventor: Po-Sheng Lai, Yilan County (TW)

(21) Appl. No.: 12/843,060

(22) Filed: Jul. 26, 2010

(51) Int. Cl. G06F 3/042

(52) U.S. Cl. 345/175

(57) ABSTRACT

The present invention of a controller of contact inductive type using optical principle for controlling a pointer on a display screen includes an optical element, an inbound light source for illuminating the optical element, and a motion transducer for receiving the reflected light from the optical element. The optical element is a lens component having the characteristics of total internal reflection. The optical element having a light source area, the inbound light source enters the optical element through the light source area. An Intensified structure is located on the bottom of the optical element for intensifying the refraction and reflection percentages of the light inside the optical element, in order to utilize the light at a higher ratio. The inbound light source is finally reflected to a contact surface on top of the optical element for placing the portion of the tip of a human digit. An array of micro structure is located on the contact surface for intensifying the brightness of the reflected light from where the portion of the tip of the human digit is placed, the light is then directed to the motion transducer through a surface on the bottom of the optical element.

### BACKGROUND OF THE INVENTION

The present invention relates to an apparatus for controlling a position of a screen pointer for an electronic device having a display screen and more particularly to a controller of contact sensing type using optical principle. U.S. Pat. No. 6,621,483 employs a contact type sensing device for controlling a position of a screen pointer for an electronic device using optical theory. The said sensing device of U.S. Pat. No. 6,621,483 having an optical element, the optical element comprising an imaging surface against which a portion of the tip of a human digit may be placed; a light source for illuminating that portion of the tip of the digit that is placed against the imaging surface, thereby generating reflected images; a lens for receiving the reflected images from the bottom part of the optical element and directing the reflected images onto a motion transducer; the motion transducer generating digital representations of the reflected images and directing the digitalized data to a controller; the controller, by employing the digitalized data, the position of the portion of the tip of a human digit placed against the imaging surface, is presented in corresponding to the coordinates of the pointer on the display screen.

U.S. Pat. No. 6,621,483 employs spherical curvature of the optical element to control the refraction of the light source and the reflection of the image. Related designs and structures are not found to intensify both the refraction and reflection effects. On account of this, the optical element having a certain vertical height for focusing and dispersing light. FIG. 1 of U.S. Pat. No. 6,621,483 indicates that the vertical height of the optical element is approximately a few times of the thickness of the portion of the tip of a human digit, thus make it impossible to have a thin controlling device. In other words, the controller of U.S. Pat. No. 6,621,483 is not suitable to be employed in slim and portable electronic devices. As mentioned previously, related designs and structures are not used to intensify both the refraction and reflection effects, weak refraction and reflection effects will thus weaken the sensitivity of the motion transducer. Corresponding position of the portion of the tip of a human digit placed against the imaging surface and the pointer's coordinates cannot be accurately and precisely presented.

### SUMMARY OF THE INVENTION

The present invention of a controller of contact sensing type using optical principle for controlling a pointer on a display screen includes an optical element, an inbound light source for illuminating the optical element, and a motion transducer for receiving the reflected light from the optical element. The optical element having a lens. The lens has the characteristics of total internal reflection. The optical element having a light source area, the inbound light source enters the optical element through the light source area. An Intensified structure is located on the bottom of the optical element for intensifying the refraction and reflection percentages of the light inside the optical element, in order to utilize the light at a higher ratio. The inbound light source is finally reflected to a contact surface on top of the optical element for placing the portion of the tip of a human digit. An array of micro structure is located on the contact surface for intensifying the brightness of the reflected light from where the portion of the tip of the human digit is placed, the light is then directed to the motion transducer through a surface on the bottom of the optical element.

The present invention of the controller of contact sensing type using optical principle for controlling a pointer on a display screen. The controller having the optical element with a length vertically much shorter than conventional optical element and prior art, thus having the advantage of a thinner height and more suitable for using in slim and portable electronic products.

The present invention has a primary objective to provide the controller of contact sensing type using optical principle for controlling a pointer on a display screen. The thin optical element employed in the controller having the intensified structure to intensify the refraction and reflection percentages. The contact surface for placing the portion of the tip of a human digit having the micro structure to intensify the brightness. As a result, the sensitivity of the present invention of the controller is enhanced by intensifying the refraction and reflection of light in order to utilize light to a higher ratio, and increasing the brightness where the digit is placed.

The present invention will become more fully understood by reference to the following detailed description thereof when read in conjunction with the attached drawings.

### BRIEF DESCRIPTION OF THE DRAWINGS

FIG. 1 is an assembly perspective view of the present invention of a controller of contact sensing type showing an inbound light source disposed under an optical element.

FIG. 2 is a side view of FIG. 1 showing how the light is being refracted and reflected.

FIG. 3 is another assembly perspective view of the present invention of a controller of contact sensing type showing an inbound light source disposed on a side of an optical element.

FIG. 4 is a side view of FIG. 3 showing how the light is being refracted and reflected.

### ELEMENTS

10—Optical element
11—Light source area
12—Surface for directing light source
13—Surface
20—Intensified structure
30—Contact surface
40—Array of micro structure for intensifying brightness
50—Inbound light source
60—Motion transducer

### DETAILED DESCRIPTION OF THE PREFERRED EMBODIMENT

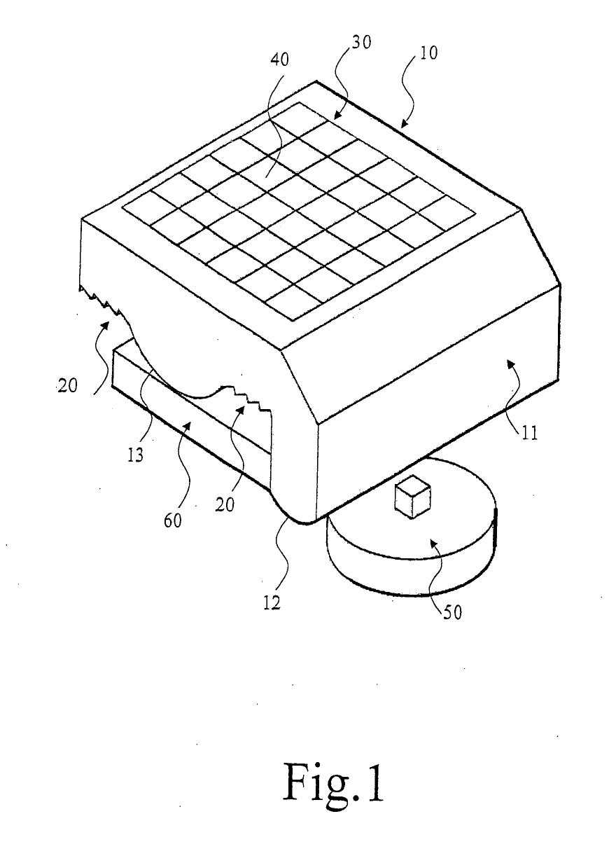

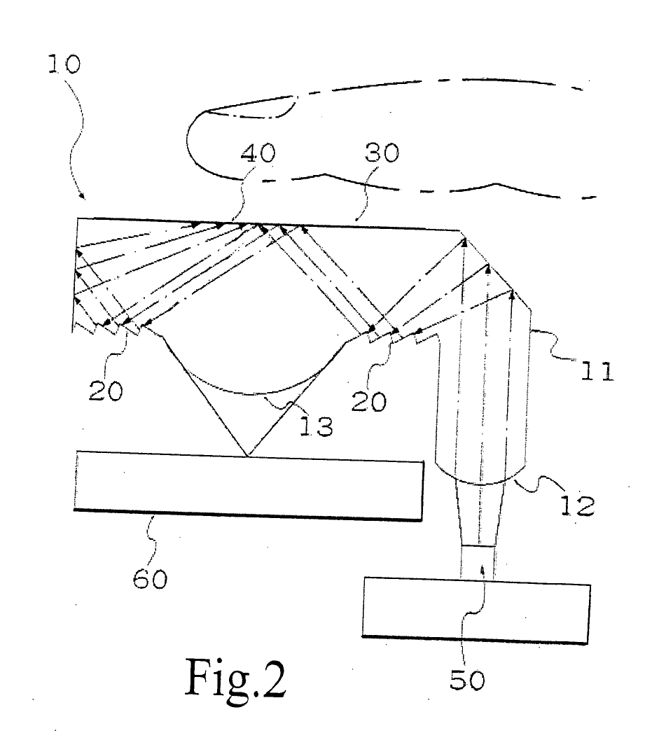

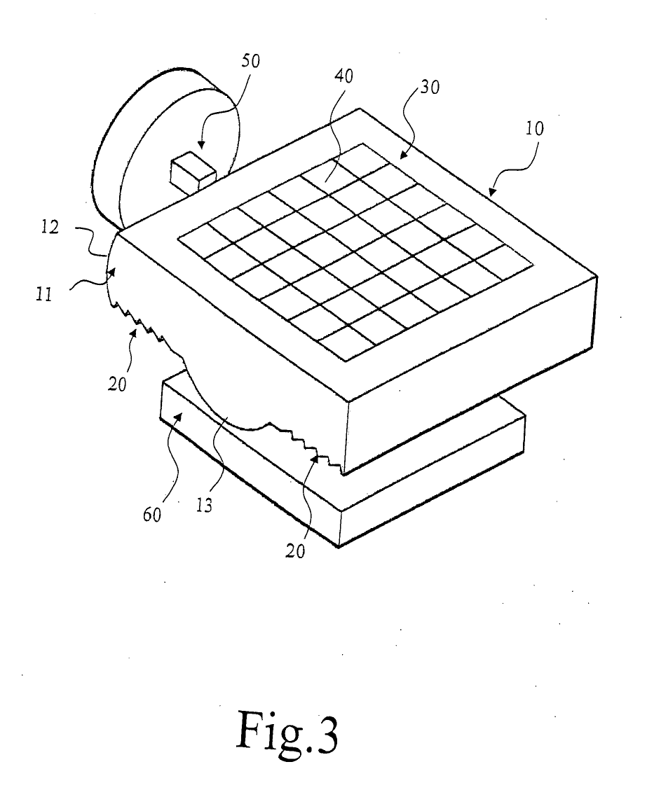

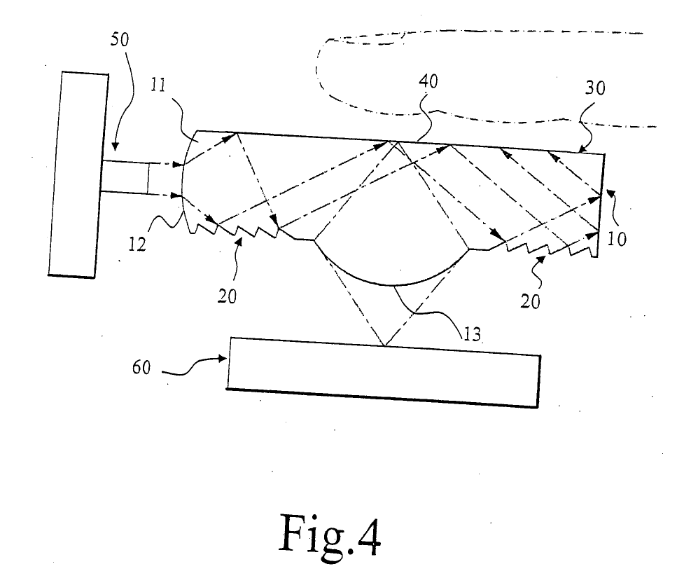

The present invention of a controller of contact sensing type using optical principle for controlling a pointer on a display screen, with reference from FIGS. 1 to 4, includes an optical element 10, an inbound light source 50 and a motion transducer 60. The inbound light source 50 and the motion transducer 60 are of prior art, thus their related principles and structures will not be described in this invention.

The optical element 10 is a lens having the characteristics of total internal reflection. The optical element 10 has a light source area 11, an intensified structure 20 for intensifying the refraction and reflection effects, a contact surface 30 for placing a portion of the tip of a human digit, an array of micro structure 40 for enhancing the brightness of the reflected light of the contact surface 30.

The light source area 11 can be disposed on top, underneath or on either side of the optical element 10. The light source area 11 having a surface for directing light source 12. The surface for directing light source 12 can be disposed on top, underneath or on either side of the light source area 11. The inbound light source 50 is disposed abutting the surface for directing light source 12. Light is illuminating on the surface for directing light source 12 and is being totally internally reflected inside the optical element 10. The surface for directing light source 12 can have a flat surface, a spherical surface of preset curvature, or periodic or non-periodic arrangements of prism pattern for intensifying the refraction and reflection effects. The inbound light source 50 can be LED(light emitting diode) or laser light but not limited to them.

The intensified structure 20 and the contact surface 30 are two opposite surfaces of the optical element 10. The intensified structure 20 is disposed on the bottom surface of the optical element 10. The contact surface 30 is disposed on the top surface of the optical element 10. A space S is between the intensified structure 20 and the contact surface 30 because of the thickness of the optical element 10 as a transparent medium. The intensified structure 20 can be a flat surface, a spherical surface of preset curvature, or periodic or non-periodic arrangements of prism pattern, the sectional shape of the prism pattern can be semi-circular, conical, pyramidical, or diamond, etc. but not limited to them. The intensified structure 20 can be formed in one piece on the surface of the optical element 10, or made individually to be attached to the surface of the optical element 10. Each prism pattern having preset height, periodical length, angle and radius of curvature.

The array of micro structure 40 for enhancing the brightness is formed by a flat surface, a spherical surface of preset curvature, or periodic or non-periodic arrangements of prism pattern. the sectional shape of the prism pattern can be semi-circular, conical, pyramidical, diamond, or any other shape but not limited to them.

The array of micro structure 40 can be formed in one piece on the surface of the optical element 10, or made individually to be attached to the surface of the optical element 10. Each prism pattern having preset height, periodical length, angle and radius of curvature.

The inbound light source 50 is directed through the surface for directing light source 12 of the light source area 11, and being totally internally reflected inside the optical element 10 and finally to the contact surface 30. The intensified structure 30 enhances the refraction and reflection effects inside the optical element 10, as a result light is utilized at a higher ratio and illuminated on the contact surface 30. Furthermore, the array of micro structure 40 of the contact surface 30 can direct the reflected light from where the portion of the tip of a human digit is placed to a special direction to achieve the effects of condensing the light and enhancing its brightness. A surface 13 is disposed on the bottom side of the optical element 10. The array of micro structure 40 directs the reflected light from where the portion of the tip of a human digit is placed to the surface 13. The surface 13 having a curvature for condensing the light onto the motion transducer 60.

The optical element 10 of the present invention having the characteristics of total internal reflection, and the intensified structure 20 further intensifies the refraction and reflection percentages of the light inside the optical element 10. The array of micro structure 40 directs the light to the surface 13, the brightness of the light is enhanced and the light itself is condensed during the process. As a result, the ratio of utilization of the light of the optical element 10 is much higher than the conventional ones and prior art. In addition, the vertical length of the optical element 10 is reduced to a large degree by employing the intensified structure 20 ad the array of micro structure 40. As a result, the optical element 10 can be made thinner for using in slim and portable electronic products. The sensitivity of the optical element 10 can be enhanced by employing the intensified structure 20 and the array micro structure 40. As a result, the sensing sensitivity of the motion transducer 60 can be utilized to the maximum. The signal conversion of the controlling element coupling with the motion transducer 60, allows the corresponding position of the portion of the tip of a human digit placed against the contact surface 30 and the pointer's coordinates to be accurately and precisely presented.

Note that the specification relating to the above embodiment should be construed as exemplary rather than as limitative of the present invention, with many variations and modifications being readily attainable by a person of average skill in the art without departing from the spirit or scope thereof as defined by the appended claims and their legal equivalents.

I claim:

1. A controller of contact sensing type using optical principle for controlling a pointer on a display screen comprising:
an optical element;
an inbound light source for illuminating said optical element;
a motion transducer for receiving the reflected light from said optical element, said optical element is a lens with the characteristics of total internal reflection, said optical element comprising:
a light source area, said inbound light source enters said optical element through said light source area;
an intensified structure abuts said light source area and is disposed on the bottom surface of said optical element, said intensified structure enhances the refraction and reflection percentages of the light inside said optical element, and reflects the light to a contact surface for placing a portion of a tip of a human digit, said contact surface is disposed on the upper surface of said optical element;
an array of micro structure for intensifying the brightness of light abuts said light source area, and is disposed on said contact surface, said array of micro structure enhances the brightness of the reflected light from where the portion of the tip of a human digit is placed, and directs the light to a surface disposed on the bottom surface of said optical element and further to said motion transducer.

2. A controller of contact sensing type using optical principle for controlling a pointer on a display screen as claimed in claim 1, said light source area is disposed on top, underneath or on either side of said optical element.

3. A controller of contact sensing type using optical principle for controlling a pointer on a display screen as claimed in claim 2, said light source area having a surface for directing light source, said surface for directing light source is disposed on top, underneath or on either side of said light source area.

4. A controller of contact sensing type using optical principle for controlling a pointer on a display screen as claimed in claim 3, said surface for directing light source can be a flat surface, a spherical surface of preset curvature, or periodic or non-periodic arrangements of prism pattern, or the combination of them, for intensifying the refraction and reflection effects.

5. A controller of contact sensing type using optical principle for controlling a pointer on a display screen as claimed in claim 1, said intensified structure can be a flat surface, a spherical surface of preset curvature, or periodic or non-periodic arrangements of prism pattern, or the combination of them.

6. A controller of contact sensing type using optical principle for controlling a pointer on a display screen as claimed in claim 5, said intensified structure can be formed in one piece on the surface of said optical element.

7. A controller of contact sensing type using optical principle for controlling a pointer on a display screen as claimed in claim 5, the sectional shape of said prism pattern can be semi-circular, conical, pyramidical or diamond.

8. A controller of contact sensing type using optical principle for controlling a pointer on a display screen as claimed in claim 5, said intensified structure can be made individually to be attached to the surface of said optical element.

9. A controller of contact sensing type using optical principle for controlling a pointer on a display screen as claimed in claim 1, said array of micro structure for intensifying the brightness of light, is formed by a flat surface, a spherical surface of preset curvature, or periodic or non-periodic arrangements of prism pattern, or the combination of them.

10. A controller of contact sensing type using optical principle for controlling a pointer on a display screen as claimed in claim 9, the sectional shape of said prism pattern can be semi-circular, conical, pyramidical or diamond.

11. A controller of contact sensing type using optical principle for controlling a pointer on a display screen as claimed in claim 9, said array of micro structure for intensifying the brightness of light, can be formed in one piece on the surface of said optical element.

12. A controller of contact sensing type using optical principle for controlling a pointer on a display screen as claimed in claim 11, said array of micro structure for intensifying the brightness of light, can be made individually to be attached to the surface of said optical element.
